(19) United States
(12) Patent Application Publication
(10) Pub. No.: US 2025/0013769 A1
(43) Pub. Date: Jan. 9, 2025

(54) MEMORY CONFIGURATION

(71) Applicant: STMicroelectronics International N.V., Geneva (CH)

(72) Inventor: Jingyi LU, Vourey (FR)

(73) Assignee: STMicroelectronics International N.V., Geneva (CH)

(21) Appl. No.: 18/762,273

(22) Filed: Jul. 2, 2024

(30) Foreign Application Priority Data
Jul. 7, 2023 (FR) 2307301

(51) Int. Cl. G06F 21/62

(52) U.S. Cl. CPC G06F 21/6218

(57) ABSTRACT

A method configures a memory for use in executing an application. The configurating the memory includes defining a set of virtual memory resources associated with one or more contiguous memory areas of the memory. Contiguous virtual memory resources of the set of virtual memory resources are selectively merged based on respective security attributes of the virtual memory resources of the set of virtual memory resources, generating a merged set of virtual memory resources. A security attribute assigned to a virtual memory resource indicates the virtual memory resource is a secure memory resource, a non-secure memory resource, or a non-secure callable memory resource. Configuration information indicative of the merged set of virtual memory resources is stored for use in executing the application.

### BACKGROUND

### Technical Field

The present disclosure relates generally to the field of circuits and electronic devices, and to the software applications that they can execute. The present disclosure relates more specifically to a configuration interface for an application executed by a processor.

### Description of the Related Art

A processor, or “Central Processing Unit” (CPU), is a complex electronic component that is used to execute a series of software instructions and so can make it possible to execute applications.

For their proper functioning, a software application may request access to various functions of a device that implements it, such as memories or other specific electronic components, etc. Before being executed by an electronic device, an application generally uses a configuration interface that makes it possible to configure the access to the various functions of the device.

### BRIEF SUMMARY

One embodiment provides a method for configuring an application executed by a processor that facilitates optimizing the number of memory ranges associated with the application and used by an application, based on values that represent security levels of said memory ranges associated with the application.

One embodiment provides a method for configuring an application executed by a processor, which facilitates optimizing the number of memory ranges associated with an access controller, and whose registered data is used by an application. The access to the memory by the application is made through the access controller. The optimization of the number of memory ranges is performed based on values that represent security levels of said memory ranges. In an embodiment, the access controller comprises one or several registers that specify memory ranges with given security levels.

One embodiment provides a method for configuring a memory to execute an application adapted to be implemented by a processor and using at least two first and second contiguous memory resources associated to an application and disposed in at least one memory area of at least one memory, wherein said method comprises a step of merging of said at least two first and second contiguous memory resources into a third memory resource if said at least two first and second parts have the same value of security attribute, wherein the method comprises a generation step of configuration data values for memory ranges of a memory.

Another embodiment provides a configuration interface adapted to execute a configuration method of a memory to execute an application adapted to be implemented by a processor and using at least two first and second contiguous memory resources associated to an application and disposed in at least one memory area of at least one memory, wherein said method comprises a step of merging of said at least two first and second memory resources into a third memory resource if said at least two first and second parts have the same value of security attribute, wherein the method comprises a generation step of configuration data values for memory ranges of a memory.

According to an embodiment, said security attribute value is the security level of a part of a memory.

According to an embodiment, said value of said attribute of a memory resource of said application can be equal to:
secure;
non-secure; or
non-secure callable.

According to an embodiment, if the value of the attribute of the first part is equal to non-secure, and if the value of the attribute of the second part is equal to non-secure callable, and if the second part is located in a memory area whose attribute value is equal to non-secure callable, then said at least two first and second parts are merged into the third part and the value of the attribute of the third part is equal to non-secure, said first part and second part being effectively contiguous.

An embodiment provides a device comprising an interface previously described.

According to an embodiment, said device comprises said processor adapted to executing the application.

According to an embodiment, said device comprises said at least one memory.

Another embodiment provides a non-transitory means readable by a computer and adapted to execute the method previously described.

In an embodiment, a method for configuring a memory for use in executing an application is provided. Configurating the memory includes: defining a set of virtual memory resources associated with one or more contiguous memory areas of the memory; selectively merging contiguous virtual memory resources of the set of virtual memory resources based on respective security attributes of the virtual memory resources of the set of virtual memory resources, generating a merged set of virtual memory resources, wherein a security attribute assigned to a virtual memory resource indicates the virtual memory resource is a secure memory resource, a non-secure memory resource, or a non-secure callable memory resource; and storing configuration information indicative of the merged set of virtual memory resources.

In an embodiment a device comprises a memory and processing circuitry coupled to the memory. The processing circuitry, in operation, configures the memory for use in executing an application, the configurating the memory including: defining a set of virtual memory resources associated with one or more contiguous memory areas of the memory; selectively merging contiguous virtual memory resources of the set of virtual memory resources based on respective security attributes of the virtual memory resources of the set of virtual memory resources, generating a merged set of virtual memory resources, wherein a security attribute assigned to a virtual memory resource indicates the virtual memory resource is a secure memory resource, a non-secure memory resource, or a non-secure callable memory resource; and storing configuration information indicative of the merged set of virtual memory resources.

In an embodiment, a system comprises processing circuitry, and an interface, which, in operation, couples the processing circuitry to a memory. The processing circuitry, in operation: defines a set of virtual memory resources associated with one or more contiguous memory areas of a memory; selectively merges contiguous virtual memory resources of the set of virtual memory resources based on respective security attributes of the virtual memory resources of the set of virtual memory resources, generating a merged set of virtual memory resources, wherein a security attribute assigned to a virtual memory resource indicates the virtual memory resource is a secure memory resource, a non-secure memory resource, or a non-secure callable memory resource; and stores configuration information indicative of the merged set of virtual memory resources.

In an embodiment, a non-transitory computer-readable medium's contents configure a processing device to perform a method, the method comprising: configuring a memory for use in executing an application, the configurating the memory including: defining a set of virtual memory resources associated with one or more contiguous memory areas of the memory; selectively merging contiguous virtual memory resources of the set of virtual memory resources based on respective security attributes of the virtual memory resources of the set of virtual memory resources, generating a merged set of virtual memory resources, wherein a security attribute assigned to a virtual memory resource indicates the virtual memory resource is a secure memory resource, a non-secure memory resource, or a non-secure callable memory resource; and storing configuration information indicative of the merged set of virtual memory resources.

### BRIEF DESCRIPTION OF THE SEVERAL VIEWS OF THE DRAWINGS

The foregoing features and advantages, as well as others, will be described in detail in the following description of specific embodiments given by way of illustration and not limitation with reference to the accompanying drawings, in which:

FIG. 1 very schematically illustrates as a block diagram an example of an electronic device to implement embodiments of FIGS. 2 to 12;

FIG. 2 very schematically illustrates as a block diagram an embodiment of a configuration interface of an application;

FIG. 3 illustrates as a block diagram an embodiment of a method to configure an application.

FIG. 4 very schematically illustrates as a block diagram an example of the implementation of the method for configuring of FIG. 3;

FIG. 5 very schematically illustrates as a block diagram an example of the implementation of the method for configuring of FIG. 3;

FIG. 6 very schematically illustrates as a block diagram an example of the implementation of the method for configuring of FIG. 3;

FIG. 7 very schematically illustrates as a block diagram an example of the implementation of the method for configuring of FIG. 3;

FIG. 8 very schematically illustrates as a block diagram an example of the implementation of the method for configuring of FIG. 3;

FIG. 9 very schematically illustrates as a block diagram an example of the implementation of the method for configuring of FIG. 3;

FIG. 10 very schematically illustrates as a block diagram an example of the implementation of the method for configuring of FIG. 3;

FIG. 11 very schematically illustrates as a block diagram an example of the implementation of the method for configuring of FIG. 3; and

FIG. 12 very schematically illustrates as a block diagram an example of the implementation of the method for configuring of FIG. 3.

### DETAILED DESCRIPTION

Like features have been designated by like references in the various figures. In particular, the structural and/or functional features that are common among the various embodiments may have the same references and may dispose identical structural, dimensional, and hardware properties.

For the sake of clarity, only the operations and elements that are useful for an understanding of the embodiments described herein have been illustrated and described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless indicated otherwise, when reference is made to absolute positional qualifiers, such as the terms “front”, “back”, “top”, “bottom”, “left”, “right”, etc., or to relative positional qualifiers, such as the terms “above”, “below”, “higher”, “lower”, etc., or to qualifiers of orientation, such as “horizontal”, “vertical”, etc., reference is made to the orientation shown in the figures.

Unless specified otherwise, the expressions “around,” “approximately,” “substantially” and “in the order of” signify within 10%, and within 5%.

The embodiments described hereafter concern a method for configuring an application executed by a processor and using memory resources associated with said processor, and the associated configuration interface. The memory resources are here portions, parts and areas in one or several real or virtual memories managed by said processor.

According to an embodiment, the configuration interface comprises several functions. A first feature allows to modify the security attribute in association with physical memory areas of a memory and then, when desired, to redefine memory areas. A second feature allows to generate a list of memory ranges in association with an application partly based on a physical division of a memory, then to optimize this list of virtual memory ranges to restrict the number of memory ranges.

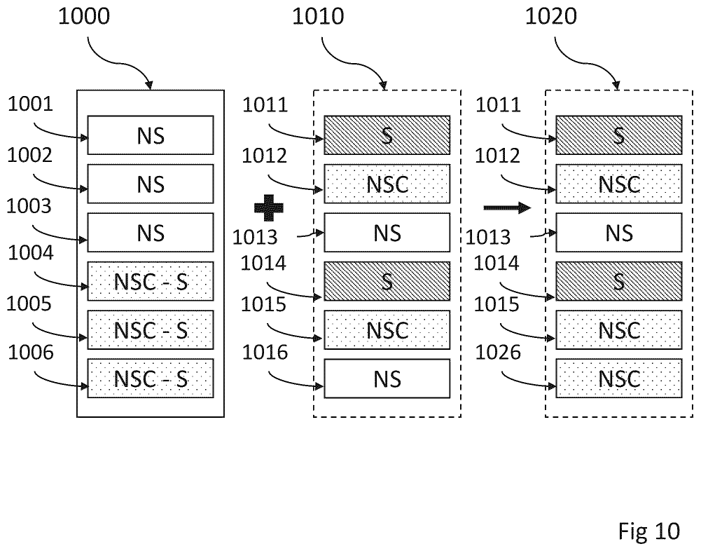

To implement these functions, the configuration interface relies on values of a security attribute associated with each memory portion, memory part or memory area and with each memory resource required by the application. More specifically, this security attribute defines whether a physical memory area is secure or not, and whether a memory resource of an application is secure, non-secure, or non-secure callable. The security attribute is described more in detail in relation with FIG. 10.

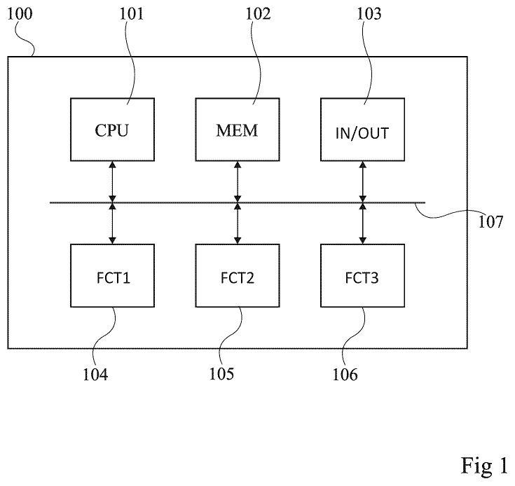

FIG. 1 very schematically illustrates as a block diagram an architecture of an example of an electronic device 100 designed to implement a software application.

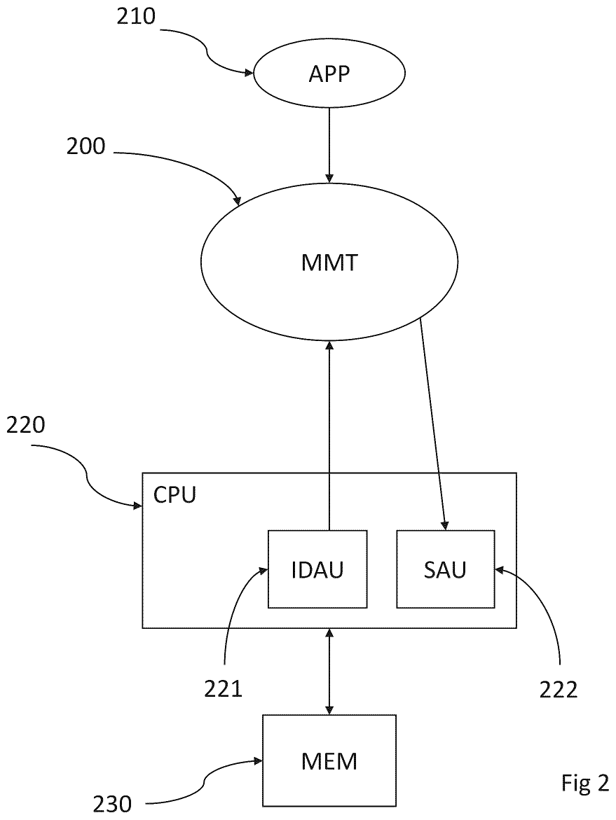

According to an embodiment, the electronic device 100 comprises a processor 101 (CPU) designed to execute various treatments of data stored in memories and/or provided by other circuits of the device 100. According to an embodiment, the processor 101 is more specifically designed to execute one or several applications as described in relation with FIG. 2.

According to an embodiment, the electronic device 100 comprises one or several memories 102 (MEM), for example memories of various types, including, for example, a non-volatile memory and/or a volatile memory. According to an embodiment, these memories are designed for use with the processor 101 and by the one or several applications that the processor executes. The treatment of the memories by the processor is described more in detail in relation with FIG. 2.

According to an embodiment, the electronic device 100 comprises input/output circuits 103 (IN/OUT) designed to execute communications of data and/or energy with a user and/or with one or several electronic devices.

The electronic device 100 as illustrated comprises various circuits 104 (FCT1), 105 (FCT2) and 106 (FCT3) designed to execute various functions. For example, the circuits 104, 105 and 106 can comprise measurement circuits, data conversion circuits, monitoring circuits for electronic or electromechanical devices, etc.

The electronic device 100 as illustrated comprises one or several data buses 107 designed to transfer data between its various components.

FIG. 2 schematically illustrates as a block diagram a configuration interface 200 (MMT) or a memory configuration tool 200 for an application 210 (APP) designed for implementation by a processor 220 (CPU) and using a memory 230 (MEM).

According to an embodiment, the application 210 is a software designed for being executed by the processor 210, and whose operation uses one or several hardware resources managed by the processor 220. More specifically, according to an embodiment, the application 210 is designed to use, at least, memory resources managed by the processor 220, for example, to read and/or store data. Memory resource refers here to a part of memory used by the application 210 to read and/or write data.

According to an embodiment, the processor 220 is of the type of the processor 101 as described in relation with FIG. 1. The processor 220 is designed to use hardware resources, such as one or several memories or other components an electronic devices to operate the application 210.

According to an example, the memory 230 is a storage of the type of those 102 as described in relation with FIG. 1. The memory 230 is made of a set of memory cells each associated with an address. A set of memory cells of a memory, hereafter called memory portion or memory area, can be defined as a list of memory addresses. The memory 230 is designed to communicate with the processor 220.

According to an embodiment, to manage the memory 230, and in particular to manage security issues related to the memory 230, the processor 220 comprises two memory attribution units 221 (IDAU) and 222 (SAU).

The memory attribution unit or circuit 221 is a hardware memory attribution unit, hereafter called hardware memory attribution unit 221, designed to divide a memory into several memory areas, and to associate them with a security attribute value. The unit 221 is called Implementation Defined Attribution Unit (IDAU). According to an example, the unit 221 is an electronic component part of the processor 220. The function of the unit 221 is to divide the memory 230 into several memory areas, which means into several sets of memory cells. This division of the memory is called a hardware division of the memory. According to an embodiment, each physical memory area is defined by:
a start address;
a size;
a facultative end address; and
a value for the security attribute.

Start address is called here the address of the first memory cell of a memory area, which means for example the address of the memory cell ranked zero in the memory area. Similarly, end address is called here the address of the last memory cell of a memory area, which means for example the address of the memory cell ranked N−1 in the memory area, where N is the integer value of the size of the memory area.

Each memory area has two possible values for the security attribute. A memory area can be secure or non-secure. A secure memory area is a part of memory, whose data values are considered as secure. In other words, the data stored in a secure part is made available only to the processor when it is in a secure state(S). According to another definition, the data stored in a secure part is accessible only by secure application capable of generating secure transactions. A non-secure memory area is a part of memory, whose data values are considered as not secure. In other words, the data stored in a non-secure part is made available to the processor when it is in a non-secure state (NS). According to another definition, the data stored in a non-secure part is accessible only by all application capable of issuing non-secure transactions. According to an example, for security reasons, all memory areas of a memory are default secure, and some of them are later defined as non-secure.

According to an embodiment, each memory area has two possible values for the security attribute. A memory area can be non-secure or non-secure callable. A non-secure callable area is a secure area, but whose access can be given to the processor when it is in a non-secure mode. When the processor works in non-secure mode, it can access a non-secure callable area when executing a specific secure instruction. According to another definition, a non-secure callable area is a secure area, but in which the functions can be called by non-secure software thanks to a secure path capable of transferring secure instructions, such as for example secure gateway (SG) instructions.

The memory attribution unit or circuit 222 is a security attribution unit designed to divide a memory into several memory ranges, and to associate them a security level or a security attribute value. The unit 222 is called Security Attribution Unit (SAU). According to an example, the unit 222 is an electronic component part of the processor 220. The data to configure a memory range is stored in registers of the memory attribution unit 222.

According to an embodiment, each memory range has three possible security levels. According to an embodiment, a memory range can be secure, non-secure, or non-secure callable. Thus, a memory range defined by the unit 222 comprises an additional security level compared to a memory range defined by the unit 221 that can comprise only two different security attribute values. A secure memory range has the same characteristics as a secure physical memory area. A non-secure memory range has the same characteristics as a non-secure physical memory area. A non-secure callable memory range has the same characteristics as a non-secure callable physical memory area.

According to an embodiment, the unit 222 is designed to provide a finite number of memory ranges. According to an example, the unit 222 is designed to provide eight memory ranges. In an embodiment, if the memory ranges provided by the unit 222 do not cover all the memory 230, the storage ranges that are not covered are assigned a default security level, such as a secure security level. Merging the memory ranges as described herein facilitates allocating specific security levels to more or to all of the ranges of a memory using the finite number of memory ranges available (e.g., reducing the number of storage ranges in the memory that are not covered by the provided finite number, and which may be assigned default security levels).

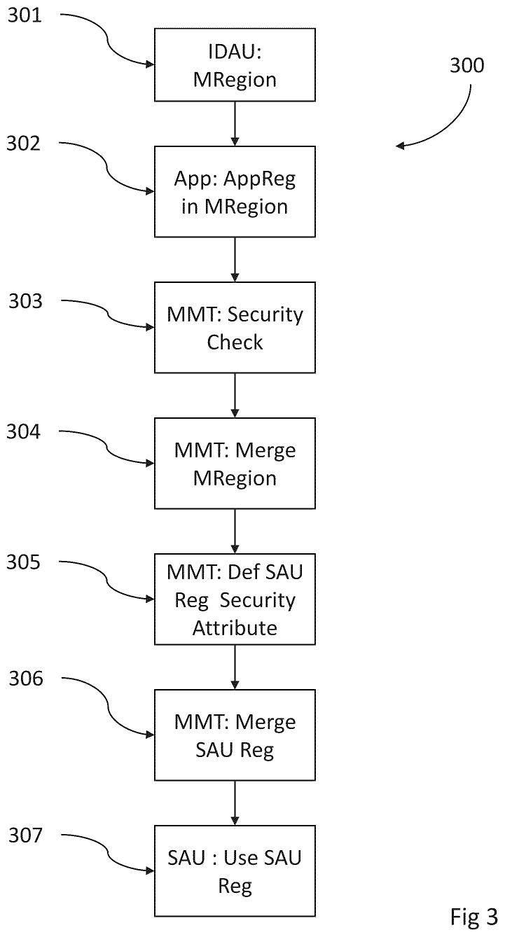

The configuration interface 200 is a software tool that allows to configure hardware resources, in particular memory resources, managed by the processor 220 for use by the application 210. To do so, the configuration interface 200 is designed to receive data from the application 210 and from the processor 220, in particular from the unit 221. The configuration interface 200 is designed to provide configuration data to the unit 222. The configuration interface 200 is particularly designed to rely on a partition of the memory 230 into memory area by the unit 221, then to provide configuration data to define the memory ranges of the unit 222 according to the memory resources required for the function of the application 210. The configuration interface 200 facilitates, among other things, optimizing the number of memory ranges and setting their security attribute values. The configuration interface 200 in an embodiment is particularly adapted to allow the designer of the application to modify the memory resources the application 210 uses, by modifying the values of their security attributes. The function of the configuration interface 200 is described more in detail in relation with FIGS. 3 to 12.

FIG. 3 is a block diagram illustrating a mode of implementation of a method 300 for configuring an application, and more specifically, a method for configuring memory areas of a memory and of memory resources used by an application, wherein the method 300 is, for example, executed by the configuration interface 200 (MMT), the application 210 (APP) and the processor 220 (CPU), all described in relation with FIG. 2.

At a step 301 (IDAU: MRegion), the processor 220 uses the hardware attribution unit 221 implemented to materially divide a memory into several memory areas. As described above, each memory area is defined by a start address, a size, a value for a security attribute and, according to an example, an end address.

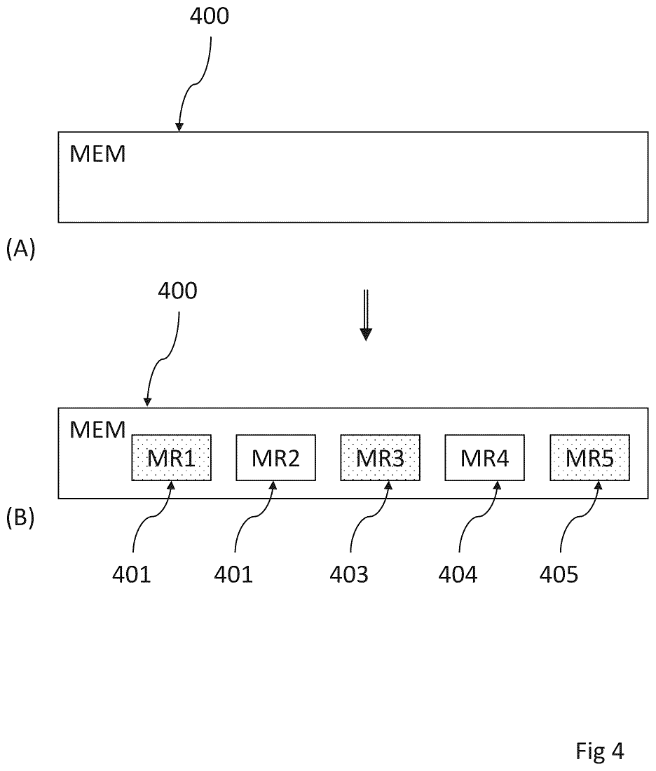

The hardware attribution unit 221 provides a list of data value groups that each represent a memory area. This list represents the hardware division of the memory 230. Based on the hardware division, the configuration interface 200 constructs another list by replacing non-secure callable memory area by secure memory area to simplify the user (designer of application) view. This list constructed by the configuration interface 200 is called hereafter the primary division of the memory. The step 301 is described more in detail in relation with FIG. 4.

At a step 302 (App: AppReg in MRegion) after the step 301, a designer of the application 210 draws up a list of memory resources the application 210 needs to work. Each memory resource is characterized by a value for the security attribute.

According to an embodiment, each memory resource has three possible security levels. According to an embodiment, a memory resource can be secure, non-secure, or non-secure callable. A secure memory resource has the same characteristics as a secure memory area or a secure physical memory area. A non-secure memory resource has the same characteristics as a non-secure memory area or a non-secure physical memory area. A non-secure callable memory resource has the same characteristics as a non-secure callable memory area or a non-secure callable physical memory area. The security level of the memory area is kept in sync with the one of the memory resource (either by setting the security level of the memory area or by moving the memory resource into a memory area having the corresponding security level).

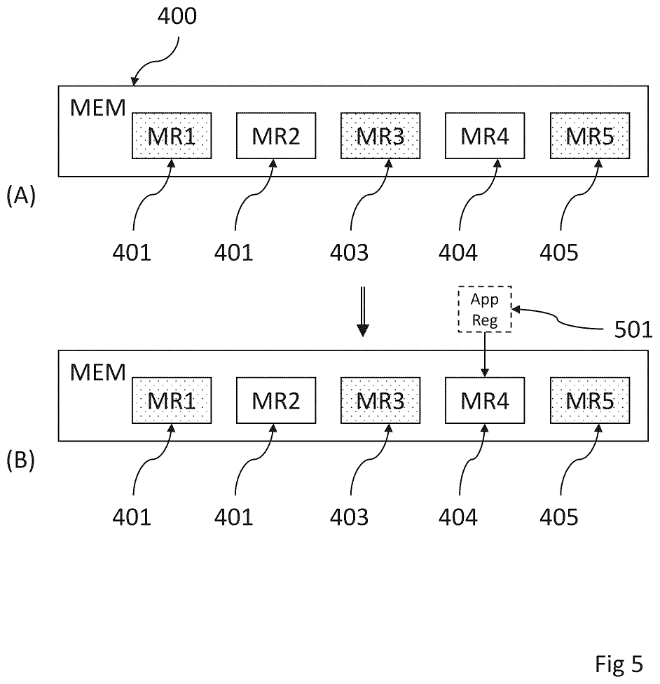

The designer of the application 210 specifies then the positions of these memory resources in the memory areas defined at the step 301. In other words, the designer of the application 210 selects, for each memory resource, the physical memory area where the memory resource is disposed. According to an example, if the designer knows the value of the security attribute of a memory resource, they can select a memory area with this security attribute value. The implementation of the step 302 is described with FIG. 5.

At a step 303 (MMT: Security Check) after the step 302, after the statement of all positions of the memory resources of the application 210, according to an implementation, the designer can decide to modify the values of the security attributes of the memory resources in the various memory areas. To do so, the designer of the application uses the configuration interface 200.

At a step 304 (MMT: Merge MRegion) after the step 303, after all the changes of step 303, the configuration interface 200 merges the contiguous memory areas with the same attribute value to get a new second division of the memory. More particularly, the configuration interface 200 merges two memory areas if they share the same security attribute and if they are contiguous. Similarly, the configuration interface 200 merges two memory areas/parts if they share the same security attribute and if they are contiguous. Moreover, the configuration interface 200 merges two memory areas/parts if one is non-secure, and the other is non-secure callable and also located in a non-secure callable area in the hardware division of the memory, and the border non-secure callable memory resource is effectively contiguous to the non-secure memory area or separated by a HW reserved memory zone.

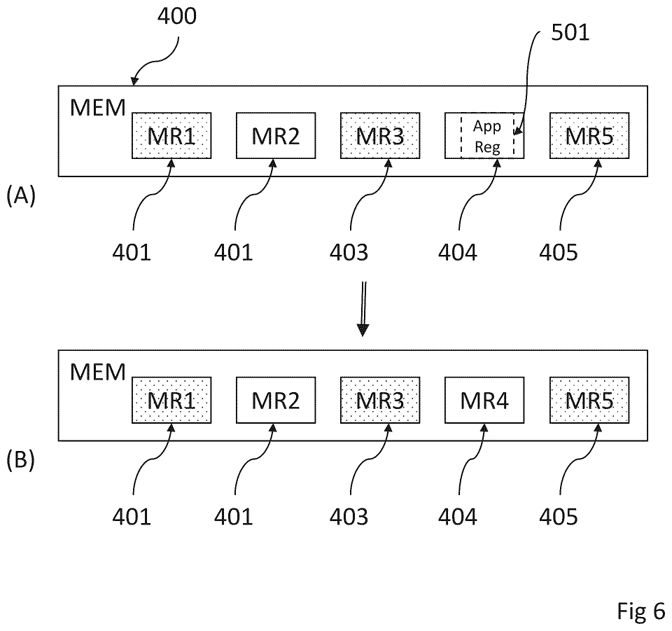

This division obtained by this step 304 is called hereafter the secondary division of the memory. This step is described more in detail in relation with FIGS. 6 to 8.

More especially, two memory resources are considered by the configuration interface 200 as contiguous:
if they are effectively contiguous;
if they are separated by a hardware reserved memory zone which is unusable and to which any access generates a bus error; or
if they are in a same aliased memory area.

The definition of “aliased memory area” is the following. An aliased memory area is a memory area wherein the physical memories are mapped to at least two different memory areas from the processor viewpoint.

Similarly, two memory areas or memory parts are considered by the configuration interface 200 as contiguous:
if their respective border memory resources are contiguous; or
if one of them does not contain any memory resources.

In an aliased memory area, the configuration interface 200 imposes the memory resource to have the same security attribute as the memory area where it's located in the hardware division of the memory. In other words, if the designer of the application changes the security attribute of a memory resource in an aliased memory area, the configuration interface 200 moves the memory resources to the memory area of the new security attribute, this memory area pointing to the same physical memory.

In an embodiment, the secondary division of the memory is used by the configuration interface 200 for the following steps of the configuration method and is not transmitted to the unit 221.

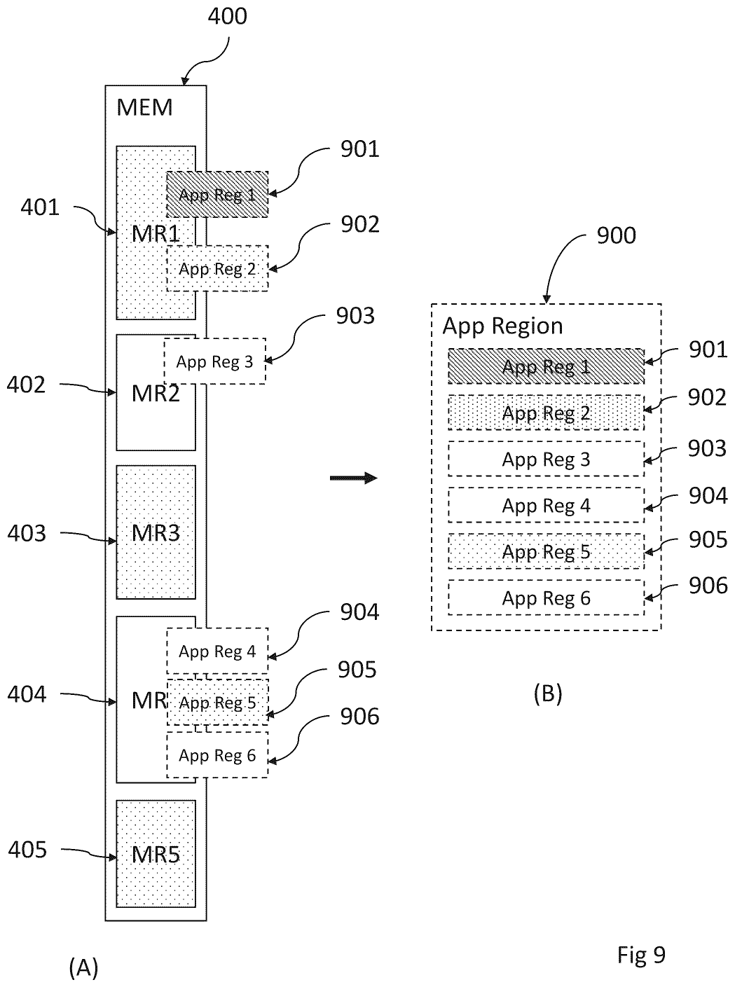

At a step 305 (MMT: Def SAU Region), after the step 304, the secondary division of the memory into memory areas is ready. It is then possible to create a set of data values that illustrates a virtual memory associated with the application 210 based on the secondary division of the memory and on the position of the memory resources used for the application 210. Here is called “virtual memory associated with the application 210” the set of the memory areas that are occupied by a memory resource of the application 210. Hence, at the step 305, the interface 200 generates a set of data values that illustrates the virtual primary memory from the secondary division of the memory and from the positions of the memory resources claimed from the application 210. This step is described more in detail in relation with FIGS. 9 and 10.

According to an example, the designer can decide to modify the values of the security attributes of the memory resources in the various memory areas at the step 305. To do so, the designer of the application uses the configuration interface 200.

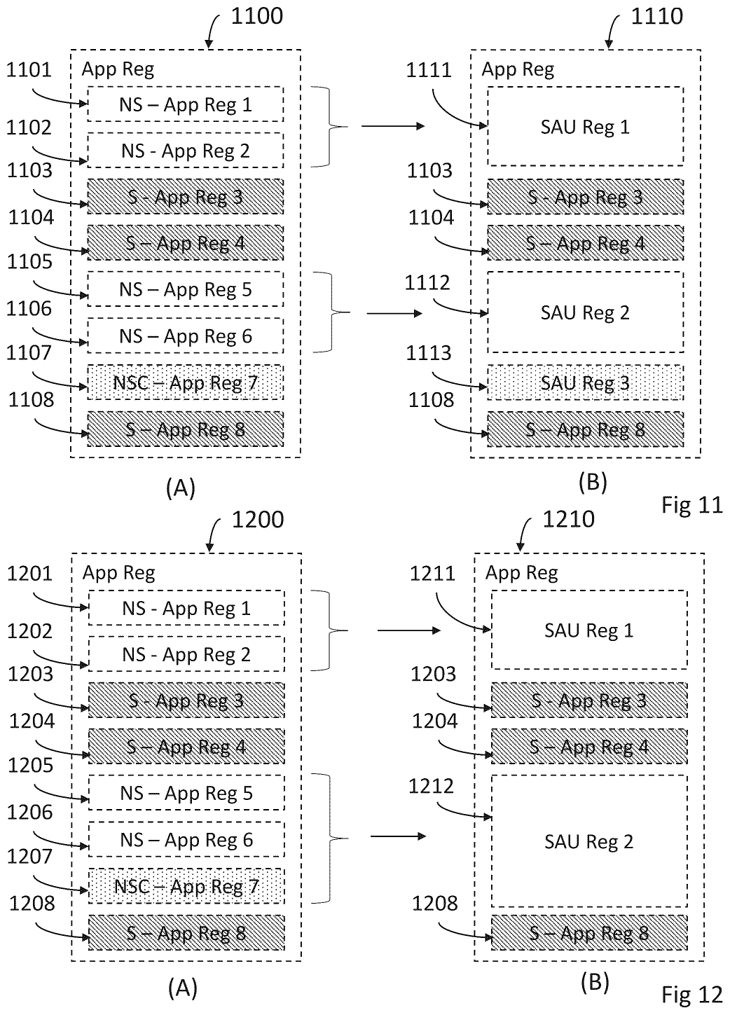

At a step 306 (MMT: Merge SAU Reg) after the step 305, once all the data values of the virtual primary memory is ready, the configuration interface 200 merges the contiguous memory areas with the same attribute value to get a set of data values that illustrates a new virtual memory comprising virtual memory resources that is called here a virtual secondary memory. Here, two memory resources are said contiguous if they are effectively contiguous or if they are separated by only memory resources that are not used by the application 210. More particularly, two memory resources are said contiguous: if they are effectively contiguous; or they are located in an aliased memory area and they are separated by only memory resources that are not used by the application 210. The memory areas pointed to the same physical memory device are called aliased memory area. For aliased memory areas, the configuration interface 200 imposes a rule that aliased non-secure memory area can only host non-secure memory resources. And the processor security hardware mechanism does not allow non-secure callable memory areas and secure memory areas to host any non-secure memory resource, in other words they can only host a non-secure callable memory resource or a secure memory resource. According to an embodiment, the configuration interface merges only the memory areas that comprise contiguous resources with the security attribute values “non-secure” and/or “non-secure callable.” This step is described more in detail in relation with FIGS. 11 and 12.

At a step 307 (SAU: Use SAU Reg), after the step 306, the data values of the virtual secondary memory are ready, the configuration interface 200 sends these data values to the software attribution unit 222 so that it generates this virtual secondary memory, more specifically the memory ranges of the virtual secondary memory. More specifically, the data values of the virtual secondary memory are configured for storage into registers. For example, these data values are memory addresses and security attribute values.

According to an embodiment, the method for configuring 300 is adapted to be executed by a non-transitory means readable by a computer.

FIG. 4 illustrates more in detail an example of implementation of the step 301 described in relation with FIG. 3.

At an initial stage (A) of the step 301, the method starts with a memory 400 (MEM) that was not divided by the hardware attribution unit. The processor 220 considers this memory as only one large memory area.

To reach the final stage (B) of the step 301, the attribution unit 221 divided the memory 400 into memory areas 401 (MR1), 402 (MR2), 403 (MR3), 404 (MR4), and 405 (MR5). The memory areas 401 to 405 can have identical or different sizes. To do so, memory cells whose security attribute value is identical are merged into a unique zone. Remember that the value of the security attribute value of a memory area can be secure, non-secure, or non-secure callable.

The attribution unit 221 draws up a list that comprises groups of data values, which define the memory areas, and sends it to the processor 220. The processor 220 uses this list when accessing memories. As specified above, this list illustrates the primary division of the memory as memory areas.

According to a previously described embodiment, the attribution unit 221 can set the value of the security attribute of a memory area only as non-secure or non-secure callable. At the final stage of the step 301, the application designer sees a non-secure callable memory area as a secure zone through the configuration interface 200. The configuration interface 200 considers non-secure callable areas of the primary division as secure areas at the final stage of the step 301.

Thus, at stage (B) of the step 301, the zones 401, 403 and 405 are non-secure callable zones and the zones 402 and 404 are non-secure zones.

FIG. 5 illustrates more in detail an example of implementation of the step 302 described in relation with FIG. 3.

At an initial stage (A) of the step 302, corresponding to the stage (B) of the step 301 described in relation with FIG. 5, the designer of the application 210 uses the configuration interface 200 to configure the memory resources of the application 210. The attribution unit 221 provides, at the configuration interface 200, the list of the primary division of the memory 400. Thus, like for FIG. 4, the memory 400 has been divided into five memory areas 401 to 405.

At a final stage (B) of the step 302, the designer specifies the positions of the memory resources of the application in the memory areas 401 to 405. In FIG. 5, it is considered that a memory resource 501 (App Reg) of the application 210 must be positioned into the memory area 404. Generally, the designer uses the configuration interface 200 to position each memory resource into a memory area with the same security attribute value.

FIG. 6 illustrates more in detail a first application case of the implementation of the step 304 described in relation with FIG. 3.

During the step 303, by using the interface 200, the designer of the application 210 had the opportunity to modify the security attribute values associated with each memory resource of the application 210.

At an initial stage (A) of the step 304, the memory resource 501 is a non-secure memory resource, but it is always positioned in a non-secure memory area.

At a final stage (B) of the step 304, the memory configuration interface 200 tries to optimize the number of memory areas by merging the contiguous memory areas with the same attribute value to get the secondary division of the memory 230. Here, all the contiguous memory areas with the same security attribute value are already merged, the secondary division of the memory remains identical to the primary division as defined by the hardware attribution unit 221.

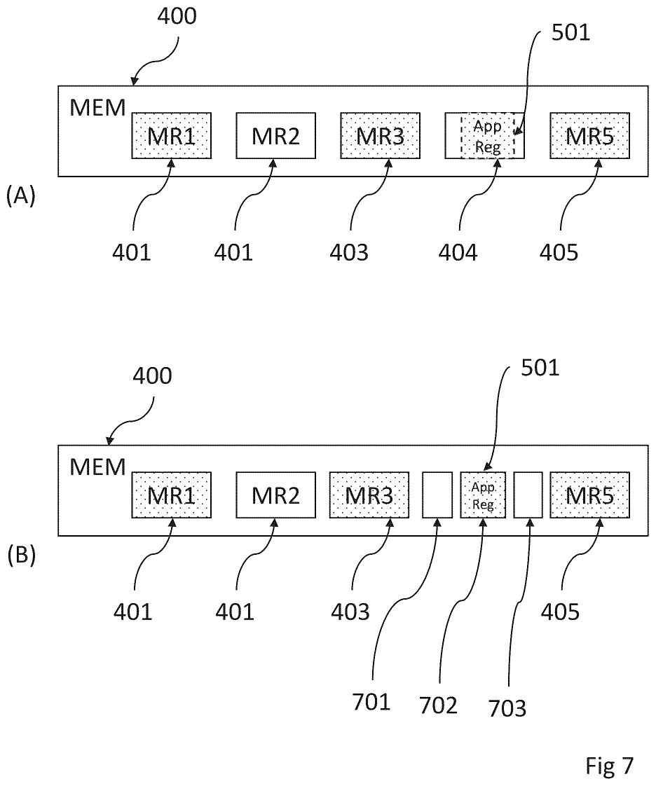

FIG. 7 illustrates more in detail a second application case of the implementation of the step 304 described in relation with FIG. 3.

At an initial stage (A) of the step 304, the memory resource 501 has become a non-secure callable memory resource and has been positioned in a non-secure memory area.

At a final stage (B) of the step 304, the memory configuration interface 200 defines the secondary division of the memory based on the memory attribute values defined at the stage (A). Thus, according to the position of the memory resource 501 in the memory area 404, the zone 404 is divided in two or three memory areas. In FIG. 7, the memory area 404 is considered as divided in three memory areas 701, 702 and 703, wherein the zones 701 and 703 are non-secure zones and the zone 702 is a non-secure callable zone. The memory resource 501 is positioned in the memory area 702.

In this case, the secondary division of the memory 400 is different from the primary division as defined by the hardware attribution unit 221.

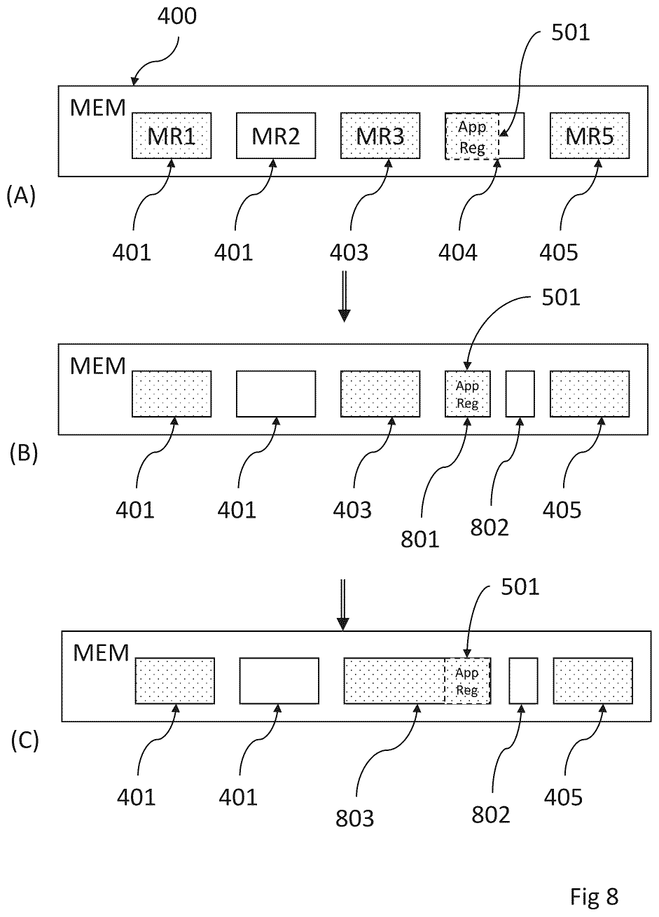

FIG. 8 illustrates more in detail a third application case of the implementation of the step 304 described in relation with FIG. 3.

At an initial stage (A) of the step 304, as in FIG. 7, the memory resource 501 has become a non-secure callable memory resource and has been positioned in a non-secure memory area.

At a stage (B) of the step 304, the memory configuration interface 200 defines the secondary division of the memory based on the memory attribute values defined at the stage (A). Thus, according to the position of the memory resource 501 in the memory area 404, the zone 404 is divided in two or three memory areas. In FIG. 8, the memory area 404 is considered as divided in two memory areas 801 and 802, wherein the zone 801 is a non-secure callable and the zone 802 is a non-secure zone. The memory resource 501 is positioned or specified in the memory area 801.

At a final stage (C) of the step 304, the memory configuration interface 200 defines the secondary division of the memory by merging the contiguous memory parts with the same security attribute values. Here, it is the case of the memory areas 403 and 801 that both are non-secure callable zones. They are then merged into a memory area 803. Thus, the memory resource 501 is positioned in the memory area 803.

In this case, the secondary division of the memory 400 is different from the primary division as defined by the hardware attribution unit 221.

FIG. 9 describes more in details an example of implementation of the step 305 as described in relation with FIG. 3.

At an initial stage (A) of the step 305, the interface 200 has available a set of data values that illustrates the secondary division of the memory and the distribution of data values that illustrate specified memory resources of the application 210 in the memory areas of the memory 230.

Thus, in FIG. 9, the memory resources of the application 210 are the following:
a secure memory resource 901 (App Reg 1) positioned in the non-secure callable memory area 401;
a non-secure callable memory resource 902 (App Reg 2) positioned in the non-secure callable memory area 401;
a non-secure memory resource 903 (App Reg 3) positioned in the non-secure memory area 402;
a non-secure memory resource 904 (App Reg 4) positioned in the non-secure memory area 404;
a non-secure memory resource 905 (App Reg 5) positioned in the non-secure memory area 404; and
a non-secure memory resource 906 (App Reg 6) positioned in the non-secure memory area 404.

According to an embodiment, the security attribute value of the memory resources can be modified according to the memory attribute value of the memory area where the memory resource is positioned. The rules of adaptation of these values are described in relation with FIG. 10.

At a final stage (B) of the step 305, the data of a virtual primary memory 900 (App Region) associated with the application 210 is generated. The virtual primary memory 900 comprises the memory resources 901 to 906. For memory, a virtual memory associated with the application is a set of data values based on the secondary division of the memory and on the position of the memory resources used for the application. This virtual memory is generated by the interface 200.

FIG. 10 very schematically illustrates as a block diagram an embodiment of the rules of combination of the security attribute values of the memory resources of an application as a function of the value of the security attribute of memory areas where they are positioned.

FIG. 10 illustrates a physical memory 1000 divided in six memory areas 1001 (NS), 1002 (NS), 1003 (NS), 1004 (NSC-S), 1005 (NSC-S), and 1006 (NSC-S). The memory areas 1001 to 1003 are non-secure memory areas and the memory areas 1004 to 1006 are, according to an embodiment, non-secure callable memory areas.

In FIG. 10 is further illustrated a list 1010 of six memory resources 1011 (S), 1012 (NSC), 1013 (NS), 1014 (S), 1015 (NSC), and 1016 (NS) of an application, each designed to be positioned into one of the memory areas 1001 to 1006. Each memory resource 1011 to 1016 comprises an attribute value that corresponds to the attribute value the designer of the application wants. More specifically, the memory resources 1011 and 1014 are secure memory resources, the memory resources 1012 and 1015 are non-secure callable memory resources, and the memory resources 1013 and 1016 are non-secure memory resources.

In the example of FIG. 10:
the memory resource 1011 is positioned in the memory area 1001;
the memory resource 1012 is positioned in the memory area 1002;
the memory resource 1013 is positioned in the memory area 1003;
the memory resource 1014 is positioned in the memory area 1004;
the memory resource 1015 is positioned in the memory area 1005; and
the memory resource 1016 is positioned in the memory area 1006.

In FIG. 10 is further illustrated a list 1020 that corresponds to the final list provided by the interface 200 to the unit 222 once the security attribute values of the memory areas and the security attribute values of the memory resources have been combined.

If a non-secure memory resource is positioned in a non-secure callable memory area, then the memory resource becomes non-secure callable. If a non-secure callable memory resource is positioned in a non-secure memory area, then the memory resource becomes non-secure callable.

According to an embodiment, the interface 200 can forbid the positioning of a non-secure memory resource into a non-secure callable memory area.

Thus, the modified list of memory resources 1020 can be generated by the interface 200 and comprises:
the secure memory resource 1011;
the non-secure callable memory resource 1012;
the non-secure memory resource 1013;
the secure memory resource 1014;
the non-secure callable memory resource 1015; and
a non-secure callable memory resource 1026.

FIG. 11 very schematically illustrates as a block diagram a first implementation mode of the steps 302 to 306 described in relation with FIG. 3.

See a list of memory resources 1100 (App Reg). The list 1100 comprises eight memory parts 1101 (NS-App Reg 1), 1102 (NS-App Reg 2), 1103 (S-App Reg 3), 1104 (S-App Reg 4), 1105 (NS-App Reg 5), 1106 (NS-App Reg 6), 1107 (NSC-App Reg 7) and 1108 (S-App Reg 8), where:
the parts 1101, 1102, 1105 and 1106 are non-secure;
the parts 1103, 1104, and 1108 are secure; and
the part 1107 is non-secure callable.

The stage (A) illustrates the list 1100 of the data values that makes it possible to provide a virtual primary memory associated to the application 210.

The stage (B) illustrates a list 1110 of data values that makes it possible to provide a virtual secondary memory associated to the application 210. In other words, at the stage (B), some memory resources have been merged. In particular, since the memory parts 1101 and 1102 are contiguous and are both non-secure memory parts, they were merged into a non-secure memory part 1111. Similarly, since the memory parts 1105 and 1106 are contiguous and are both non-secure memory parts, they were merged into a non-secure memory part 1112.

Thus, at the end of step 306, the virtual secondary memory associated with the application comprises fewer memory parts than the non-optimized virtual primary memory.

FIG. 12 very schematically illustrates as a block diagram a second implementation mode of the steps 302 to 306 described in relation with FIG. 3.

See a list of memory resources 1200 (App Reg). The list 1200 comprises eight memory parts 1201 (NS-App Reg 1), 1202 (NS-App Reg 2), 1203 (S-App Reg 3), 1204 (S-App Reg 4), 1205 (NS-App Reg 5), 1206 (NS-App Reg 6), 1207 (NSC-App Reg 7) and 1208 (S-App Reg 8), where:
the parts 1201, 1202, 1205 and 1206 are non-secure;
the parts 1203, 1204, and 1208 are secure; and
the part 1207 is non-secure callable.

The stage (A) illustrates the list 1200 of the data values that makes it possible to provide a virtual primary memory associated to the application 210.

The stage (B) illustrates a list 1210 of data values that makes it possible to provide a virtual secondary memory associated to the application 210. In other words, at the stage (B), some memory resources have been merged. In particular, since the memory parts 1201 and 1202 are contiguous and are both non-secure memory parts, they were merged into a non-secure memory range 1211 (SAU Reg 1). The definition of the word “contiguous” is the one given earlier.

In addition, according to a variant of the embodiment above as described in relation with FIG. 11, it is considered here that if a non-secure callable memory resource is effectively contiguous a non-secure memory part or area, and if this non-secure callable memory resource is positioned in a memory area considered as a non-secure callable memory area in the primary division, then both memory parts can be merged into a non-secure memory part. Thus, the memory parts 1205, 1206 and 1207 are merged into a non-secure memory range 1212 (SAU Reg 2).

Thus, at the end of step 306, the virtual secondary memory associated with the application comprises fewer memory resources than the non-optimized virtual primary memory.

Various embodiments and variants have been described. Those skilled in the art will understand that certain features of these embodiments can be combined and other variants will readily occur to those skilled in the art.

Finally, the practical implementation of the embodiments and variants described herein is within the capabilities of those skilled in the art based on the functional description provided hereinabove.

An embodiment of a method for configuring (300) a memory (230) to execute an application (210) adapted to be implemented by a processor (101; 220) and using at least two first and second contiguous memory resources (401 to 405; 901 to 906; 1101 to 1108; 1201 to 1208) associated to an application and disposed in at least one memory area (401 to 405) of at least one memory (102; 230; 400; 900; 1100; 1200) is disclosed. The method (300) comprises a step of merging (306) of said at least two first and second contiguous memory resources (901 to 906; 1101 to 1108; 1201 to 1208) into a third memory resource (803; 1111; 1112; 1211, 1212) if said at least two first and second parts (901 to 906; 1101 to 1108; 1201 to 1208) have the same value of security attribute, wherein the method includes a generation step (307) of configuration data values for memory ranges of a memory (102; 230; 400; 900; 1100; 1200).

An embodiment of a configuration interface (200) adapted to execute a configuration method (300) of a memory (230) to execute an application (210) adapted to be implemented by a processor (101; 220) and using at least two first and second contiguous memory resources (401 to 405; 901 to 906; 1101 to 1108; 1201 to 1208) associated to an application and disposed in at least one memory area (401 to 405) of at least one memory (102; 230; 400; 900; 1100; 1200) is disclosed. The method (300) comprises a step of merging (306) of said at least two first and second memory resources (901 to 906; 1101 to 1108; 1201 to 1208) into a third memory resource (803; 1111; 1112; 1211, 1212) if said at least two first and second parts (901 to 906; 1101 to 1108; 1201 to 1208) have the same value of security attribute, wherein the method may further include a generation step (307) of configuration data values for memory ranges of a memory (102; 230; 400; 900; 1100; 1200).

In an embodiment, the security attribute value is the security level of a part (401 to 405; 901 to 906; 1101 to 1108; 1201 to 1208) of a memory (102; 230; 400; 900; 1100; 1200).

In an embodiment, the value of said attribute of a memory resource (901 to 906; 1101 to 1108; 1201 to 1208) of said application (210) may be equal to: secure; non-secure; and non-secure callable.

In an embodiment, if the value of the attribute of the first part (1206) is equal to non-secure, and if the value of the attribute of the second part (1207) is equal to non-secure callable, and if the second part (1207) is located in a memory area considered as non-secure callable by the first memory division, and the second part (1207) is effectively contiguous to the first part (1206), then said at least two first and second parts (1206, 1207) are merged into the third part (1212) and the value of the attribute of the third part (1212) is equal to non-secure.

In an embodiment, a method for configuring a memory for use in executing an application is provided. Configurating the memory includes: defining a set of virtual memory resources associated with one or more contiguous memory areas of the memory; selectively merging contiguous virtual memory resources of the set of virtual memory resources based on respective security attributes of the virtual memory resources of the set of virtual memory resources, generating a merged set of virtual memory resources, wherein a security attribute assigned to a virtual memory resource indicates the virtual memory resource is a secure memory resource, a non-secure memory resource, or a non-secure callable memory resource; and storing configuration information indicative of the merged set of virtual memory resources.

In an embodiment, the information indicative of the merged set of virtual memory resources comprises configuration data values for one or more memory ranges of the memory. In an embodiment, the configuration data values include memory addresses and security attribute values.

In an embodiment, the selectively merging comprises merging contiguous virtual memory resources of the set of virtual memory resources having a same security attribute indicating the contiguous virtual memory resources are non-secure memory resources. In an embodiment, the selectively merging comprises merging contiguous virtual memory resources of the set of virtual memory resources having security attributes indicating the contiguous virtual memory resources are non-secure memory resources or non-secure callable memory resources.

In an embodiment, the selectively merging comprises merging contiguous virtual memory resources of the set of virtual memory resources having security attributes indicating the contiguous virtual memory resources are non-secure memory resources or non-secure callable memory resources. In an embodiment, the merged contiguous virtual memory resource has a security attribute value indicating the merged contiguous virtual memory resource is a non-secure virtual memory resource.

In an embodiment, the method comprises: executing the application using the memory and based on the stored configuration information indicative of the merged set of virtual memory resources.

In an embodiment a device comprises a memory and processing circuitry coupled to the memory. The processing circuitry, in operation, configures the memory for use in executing an application, the configurating the memory including: defining a set of virtual memory resources associated with one or more contiguous memory areas of the memory; selectively merging contiguous virtual memory resources of the set of virtual memory resources based on respective security attributes of the virtual memory resources of the set of virtual memory resources, generating a merged set of virtual memory resources, wherein a security attribute assigned to a virtual memory resource indicates the virtual memory resource is a secure memory resource, a non-secure memory resource, or a non-secure callable memory resource; and storing configuration information indicative of the merged set of virtual memory resources.

In an embodiment, the information indicative of the merged set of virtual memory resources comprises configuration data values for one or more memory ranges of the memory. In an embodiment, the configuration data values include memory addresses and security attribute values.

In an embodiment, the selectively merging comprises merging contiguous virtual memory resources of the set of virtual memory resources having a same security attribute indicating the contiguous virtual memory resources are non-secure memory resources. In an embodiment, the selectively merging comprises merging contiguous virtual memory resources of the set of virtual memory resources having security attributes indicating the contiguous virtual memory resources are non-secure memory resources or non-secure callable memory resources.

In an embodiment, the selectively merging comprises merging contiguous virtual memory resources of the set of virtual memory resources having security attributes indicating the contiguous virtual memory resources are non-secure memory resources or non-secure callable memory resources. In an embodiment, the merged contiguous virtual memory resource has a security attribute value indicating the merged contiguous virtual memory resource is a non-secure virtual memory resource.

In an embodiment, the processing circuitry, in operation: executes the application using the memory and based on the stored configuration information indicative of the merged set of virtual memory resources.

In an embodiment, a system comprises processing circuitry, and an interface, which, in operation, couples the processing circuitry to a memory. The processing circuitry, in operation: defines a set of virtual memory resources associated with one or more contiguous memory areas of a memory; selectively merges contiguous virtual memory resources of the set of virtual memory resources based on respective security attributes of the virtual memory resources of the set of virtual memory resources, generating a merged set of virtual memory resources, wherein a security attribute assigned to a virtual memory resource indicates the virtual memory resource is a secure memory resource, a non-secure memory resource, or a non-secure callable memory resource; and stores configuration information indicative of the merged set of virtual memory resources. In an embodiment, the processing circuitry, in operation, implements a configuration tool to perform the selective merging and the storing of the configuration information. In an embodiment, the system comprises the memory. In an embodiment, the system comprises an integrated circuit including the processing circuitry, the interface, and the memory.

In an embodiment, a non-transitory computer-readable medium's contents configure a processing device to perform a method, the method comprising: configuring a memory for use in executing an application, the configurating the memory including: defining a set of virtual memory resources associated with one or more contiguous memory areas of the memory; selectively merging contiguous virtual memory resources of the set of virtual memory resources based on respective security attributes of the virtual memory resources of the set of virtual memory resources, generating a merged set of virtual memory resources, wherein a security attribute assigned to a virtual memory resource indicates the virtual memory resource is a secure memory resource, a non-secure memory resource, or a non-secure callable memory resource; and storing configuration information indicative of the merged set of virtual memory resources. In an embodiment, the selectively merging comprises merging contiguous virtual memory resources of the set of virtual memory resources having a same security attribute indicating the contiguous virtual memory resources are non-secure memory resources. In an embodiment, the selectively merging comprises merging contiguous virtual memory resources of the set of virtual memory resources having security attributes indicating the contiguous virtual memory resources are non-secure memory resources or non-secure callable memory resources. In an embodiment, the contents comprise instructions executed by the processing device.

Some embodiments may take the form of or comprise computer program products. For example, according to one embodiment there is provided a computer readable medium comprising a computer program adapted to perform one or more of the methods or functions described above. The medium may be a physical storage medium, such as for example a Read Only Memory (ROM) chip, or a disk such as a Digital Versatile Disk (DVD-ROM), Compact Disk (CD-ROM), a hard disk, a memory, a network, or a portable media article to be read by an appropriate drive or via an appropriate connection, including as encoded in one or more barcodes or other related codes stored on one or more such computer-readable mediums and being readable by an appropriate reader device.

Furthermore, in some embodiments, some or all of the methods and/or functionality may be implemented or provided in other manners, such as at least partially in firmware and/or hardware, including, but not limited to, one or more application-specific integrated circuits (ASICs), digital signal processors, discrete circuitry, logic gates, standard integrated circuits, controllers (e.g., by executing appropriate instructions, and including microcontrollers and/or embedded controllers), field-programmable gate arrays (FPGAs), complex programmable logic devices (CPLDs), etc., as well as devices that employ RFID technology, and various combinations thereof.

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
configuring a memory for use in executing an application, the configurating the memory including:
defining a set of virtual memory resources associated with one or more contiguous memory areas of the memory;
selectively merging contiguous virtual memory resources of the set of virtual memory resources based on respective security attributes of the virtual memory resources of the set of virtual memory resources, generating a merged set of virtual memory resources, wherein a security attribute assigned to a virtual memory resource indicates the virtual memory resource is a secure memory resource, a non-secure memory resource, or a non-secure callable memory resource; and
storing configuration information indicative of the merged set of virtual memory resources.

2. The method of claim 1, wherein the information indicative of the merged set of virtual memory resources comprises configuration data values for one or more memory ranges of the memory.

3. The method of claim 2, wherein the configuration data values include memory addresses and security attribute values.

4. The method of claim 1, wherein the selectively merging comprises merging contiguous virtual memory resources of the set of virtual memory resources having a same security attribute indicating the contiguous virtual memory resources are non-secure memory resources.

5. The method of claim 4, wherein the selectively merging comprises merging contiguous virtual memory resources of the set of virtual memory resources having security attributes indicating the contiguous virtual memory resources are non-secure memory resources or non-secure callable memory resources.

6. The method of claim 1, wherein the selectively merging comprises merging contiguous virtual memory resources of the set of virtual memory resources having security attributes indicating the contiguous virtual memory resources are non-secure memory resources or non-secure callable memory resources.

7. The method of claim 6, wherein the merged contiguous virtual memory resource has a security attribute value indicating the merged contiguous virtual memory resource is a non-secure virtual memory resource.

8. The method of claim 1, comprising:
executing the application using the memory and based on the stored configuration information indicative of the merged set of virtual memory resources.

9. A device, comprising:
a memory;
processing circuitry coupled to the memory, wherein the processing circuitry, in operation, configures the memory for use in executing an application, the configurating the memory including:
defining a set of virtual memory resources associated with one or more contiguous memory areas of the memory;
selectively merging contiguous virtual memory resources of the set of virtual memory resources based on respective security attributes of the virtual memory resources of the set of virtual memory resources, generating a merged set of virtual memory resources, wherein a security attribute assigned to a virtual memory resource indicates the virtual memory resource is a secure memory resource, a non-secure memory resource, or a non-secure callable memory resource; and
storing configuration information indicative of the merged set of virtual memory resources.

10. The device of claim 9, wherein the information indicative of the merged set of virtual memory resources comprises configuration data values for one or more memory ranges of the memory.

11. The device of claim 10, wherein the configuration data values include memory addresses and security attribute values.

12. The device of claim 9, wherein the selectively merging comprises merging contiguous virtual memory resources of the set of virtual memory resources having a same security attribute indicating the contiguous virtual memory resources are non-secure memory resources.

13. The device of claim 12, wherein the selectively merging comprises merging contiguous virtual memory resources of the set of virtual memory resources having security attributes indicating the contiguous virtual memory resources are non-secure memory resources or non-secure callable memory resources.

14. The device of claim 9, wherein the selectively merging comprises merging contiguous virtual memory resources of the set of virtual memory resources having security attributes indicating the contiguous virtual memory resources are non-secure memory resources or non-secure callable memory resources.

15. The device of claim 14, wherein the merged contiguous virtual memory resource has a security attribute value indicating the merged contiguous virtual memory resource is a non-secure virtual memory resource.

16. The device of claim 9, wherein the processing circuitry, in operation:
executes the application using the memory and based on the stored configuration information indicative of the merged set of virtual memory resources.

17. A system, comprising:
processing circuitry; and
an interface, which, in operation, couples the processing circuitry to a memory, wherein the processing circuitry, in operation:
defines a set of virtual memory resources associated with one or more contiguous memory areas of a memory;
selectively merges contiguous virtual memory resources of the set of virtual memory resources based on respective security attributes of the virtual memory resources of the set of virtual memory resources, generating a merged set of virtual memory resources, wherein a security attribute assigned to a virtual memory resource indicates the virtual memory resource is a secure memory resource, a non-secure memory resource, or a non-secure callable memory resource; and
stores configuration information indicative of the merged set of virtual memory resources.

18. The system of claim 17, wherein the processing circuitry, in operation, implements a configuration tool to perform the selective merging and the storing of the configuration information.

19. The system of claim 17, comprising:
the memory.

20. The system of claim 19, comprising:
an integrated circuit including the processing circuitry, the interface, and the memory.

21. A non-transitory computer-readable medium having contents which configure a processing device to perform a method, the method comprising:
configuring a memory for use in executing an application, the configurating the memory including:
defining a set of virtual memory resources associated with one or more contiguous memory areas of the memory;
selectively merging contiguous virtual memory resources of the set of virtual memory resources based on respective security attributes of the virtual memory resources of the set of virtual memory resources, generating a merged set of virtual memory resources, wherein a security attribute assigned to a virtual memory resource indicates the virtual memory resource is a secure memory resource, a non-secure memory resource, or a non-secure callable memory resource; and
storing configuration information indicative of the merged set of virtual memory resources.

22. The non-transitory computer-readable medium of claim 21, wherein the selectively merging comprises merging contiguous virtual memory resources of the set of virtual memory resources having a same security attribute indicating the contiguous virtual memory resources are non-secure memory resources.

23. The non-transitory computer-readable medium of claim 22, wherein the selectively merging comprises merging contiguous virtual memory resources of the set of virtual memory resources having security attributes indicating the contiguous virtual memory resources are non-secure memory resources or non-secure callable memory resources.

24. The non-transitory computer-readable medium of claim 21, wherein the selectively merging comprises merging contiguous virtual memory resources of the set of virtual memory resources having security attributes indicating the contiguous virtual memory resources are non-secure memory resources or non-secure callable memory resources.

25. The non-transitory computer-readable medium of claim 21, wherein the contents comprise instructions executed by the processing device.
